(19) United States
(12) Patent Application Publication
(10) Pub. No.: US 2018/0220229 A1
(43) Pub. Date: Aug. 2, 2018

(54) SPEAKER APPARATUS, SPEAKER SYSTEM, AND CONTROL METHOD OF SPEAKER APPARATUS

(71) Applicant: DENSO TEN Limited, Kobe-shi (JP)

(72) Inventors: Keiichiro TANAKA, Kobe-shi (JP); Masahiko KUBO, Kobe-shi (JP)

(73) Assignee: DENSO TEN Limited, Kobe-shi (JP)

(21) Appl. No.: 15/875,243

(22) Filed: Jan. 19, 2018

(30) Foreign Application Priority Data
Jan. 30, 2017 (JP) 2017-014506

(51) Int. Cl. H04R 1/40; H04R 1/02; H04R 1/44

(52) U.S. Cl. CPC H04R 1/403; H04R 2400/03; H04R 1/44; H04R 1/025

(57) ABSTRACT

A speaker apparatus according to an embodiment includes a panel, one or more vibration elements, an acquisition unit, and an application unit. The one or more vibration elements are arranged the panel so as to vibrate the panel. The acquisition unit acquires sound information. The application unit applies, to the one or more vibration elements, a driving signal of a specific frequency generating a standing wave in the panel, on the basis of the sound information acquired by the acquisition unit.

### CROSS-REFERENCE TO RELATED APPLICATION

This application is based upon and claims the benefit of priority of the prior Japanese Patent Application No. 2017-014506, filed on Jan. 30, 2017 the entire contents of which are incorporated herein by reference.

### FIELD

The embodiment discussed herein is directed to a speaker apparatus, a speaker system, and a control method of the speaker apparatus.

### BACKGROUND

Conventionally, there is known a speaker apparatus that has the directivity. This speaker apparatus utilizes an ultrasonic wave as a carrier wave to be able to generate an audible sound only in a specific direction (see Japanese Laid-open Patent Publication No. 2011-010224, for example).

However, in the conventional speaker apparatus, a large number of elements are to be arranged in array in order to exert the directivity, and thus it is difficult to miniaturize the speaker apparatus.

### SUMMARY

A speaker apparatus according to an embodiment includes a panel, one or more vibration elements, an acquisition unit, and an application unit. The one or more vibration elements are arranged the panel so as to vibrate the panel. The acquisition unit acquires sound information. The application unit applies, to t one or more vibration elements, a driving signal of a specific frequency for generating a standing wave in the panel, on the basis of the sound information acquired by the acquisition unit.

### BRIEF DESCRIPTION OF DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a diagram illustrating the outline of a speaker apparatus;

FIG. 2 is a block diagram illustrating a speaker system;

FIG. 3A is a diagram illustrating relation between a directivity angle and a frequency of a standing wave;

FIG. 3B is a diagram illustrating one example of attached positions of vibration elements on a panel;

FIG. 4A is a diagram illustrating parts for fixing the panel;

FIG. 4B is a side view illustrating the panel that is fixed to a fixed part;

FIG. 5 is a flowchart illustrating a procedure for processes to be executed by the speaker apparatus; and

FIGS. 6A and 6B are diagrams illustrating specific examples of positions for attaching the panel.

### DESCRIPTION OF EMBODIMENT

Hereinafter, an exemplary embodiment of a speaker apparatus, a speaker system, and a control method of the speaker apparatus disclosed in the present application will be described in detail with reference to the accompanying drawings. Moreover, it is not intended that the present disclosure be limited to the embodiment described below.

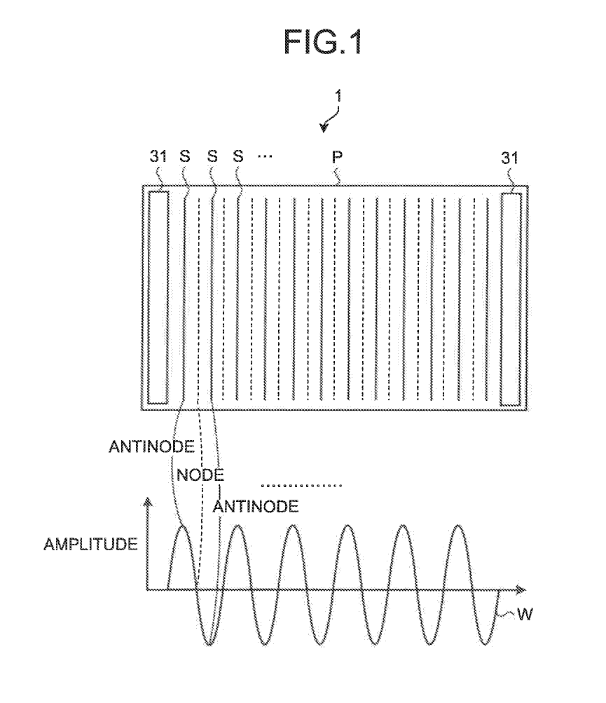

First, the outline of a speaker apparatus according to the embodiment will be explained with reference to FIG. 1. FIG. 1 is a diagram illustrating the outline of a speaker apparatus 1. As illustrated in FIG. I, the speaker apparatus 1 includes a panel P and vibration elements 31.

The panel P is made of, for example, glass having a rectangular shape, and is vibrated in response to vibration of the vibration elements 31. The panel P may be made of another material such as metal and plastic, not limited to glass. The panel P may have another shape such as a square shape, a circular shape, and a triangular shape, not limited to the rectangular shape.

The vibration elements 31 include piezo elements, for example, and are arranged in end parts of the panel P. The vibration elements 31 expand and contract in accordance with an applied driving signal of an Alternating-Current voltage (AC voltage) so as to vibrate the panel P. The case is exemplified in which the number of the vibration elements 31 is two, the number of the vibration elements 31 may be one or equal to or more than three.

Meanwhile, commonly, a speaker apparatus having the directivity generates ultrasonic waves modulated by a sound signal of an audible frequency band, and the sound signal is demodulated by the nonlinear feature when these ultrasonic waves are propagated in the air, so as to occur an audible sound.

However, in a conventional speaker apparatus (namely, parametric speaker), a large number of elements for generating ultrasonic waves are to be arranged in array, and thus it is difficult to miniaturize the apparatus.

Therefore, the speaker apparatus 1 according to the embodiment causes the panel P to vibrate, and generates line-shaped sound sources S on the panel P so as to miniaturize a speaker apparatus having the directivity.

Specifically, the speaker apparatus 1 acquires sound information, and applies, on the ba of this sound information, a driving signal of a specific frequency f for generating a standing wave in the panel P to the vibration elements 31. This sound information includes the above sound signal, for example. The vibration elements 31 are vibrated by the driving signal of the specific frequency f, and the panel P resonates so as to generate a standing wave W in the panel P as illustrated in FIG. 1. In FIG. 1, antinodes of the standing wave W are indicated by solid lines and nodes of the standing wave W are indicated by dashed lines.

In this manner, the speaker apparatus 1 according to the embodiment generates the standing wave W in the panel P to be able to cause the antinodes of the standing wave W to function as the line-shaped sound sources S. These line-shaped sound sources S are formed at equal intervals along a direction in which the two vibration elements 31 oppose to each other. The speaker apparatus according to the embodiment causes the line-shaped sound sources S generated in the panel P to vibrate in an ultrasonic band to be able to generate ultrasonic waves from these line-shaped sound sources S.

In this manner, in the speaker apparatus according to the embodiment, the line-shaped sound sources S generated in the panel P carry out functions of elements of the conventional speaker apparatus that are arranged in array. Thus, unlike the conventional one, the speaker apparatus 1 according to the embodiment does not need a large number of elements arranged in array.

Therefore, by employing the speaker apparatus 1 according to the embodiment, it is possible to miniaturize a speaker apparatus having the directivity.

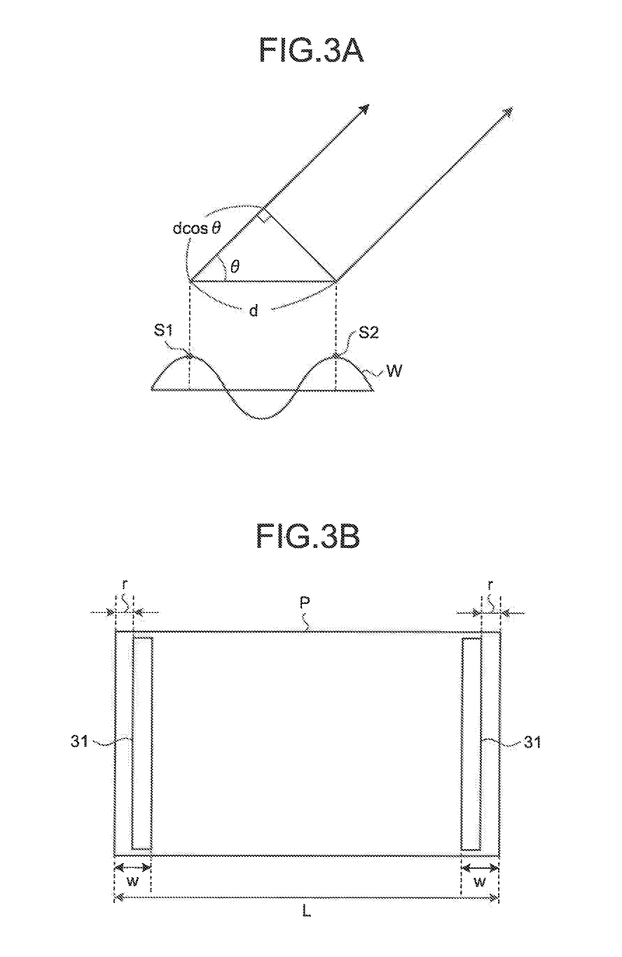

Meanwhile, the conventional speaker apparatus needs complicated control for changing a direction (hereinafter, may be referred to as “directivity angle A”) in which a sound is generated. The speaker apparatus 1 according to the embodiment is able to easily change the directivity angle A. Details in this point will be mentioned later with reference to FIGS. 3A and 3B.

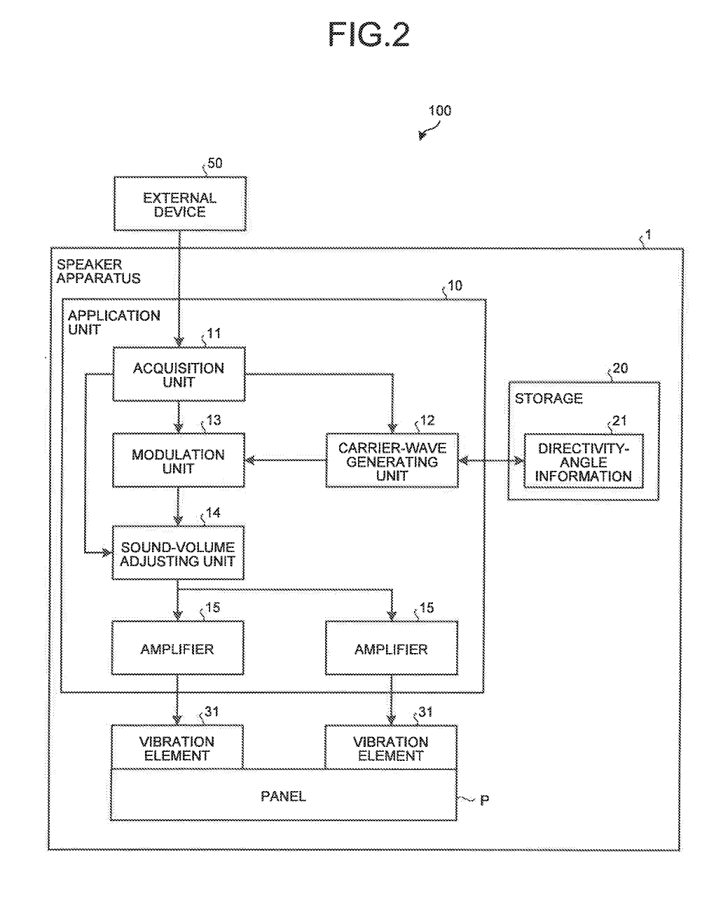

Next, a configuration of a speaker system 100 including the speaker apparatus 1 according to the embodiment will be explained with reference to FIG. 2. FIG. 2 is a block diagram illustrating the speaker system 100.

As illustrated in FIG. 2, the speaker system 100 includes the speaker apparatus 1 and an external device 50. The external device 50 includes, for example, a personal computer, a smartphone, a home audio system, a car audio device, a car navigation system, another music reproducing device, among other things.

The external device 50 outputs, to the speaker apparatus 1, sound information including a sound signal of an audible frequency band, a directivity-angle signal for specifying the directivity angle A, and a sound-volume signal for specifying a sound volume. The sound signal, the directivity-angle signal, and the sound-volume signal are one example of in sign that are input to the speaker apparatus 1 from the external device 50.

In the speaker system 100, the speaker apparatus 1 may be provided with an antenna for receiving the radio broadcast and the television broadcast, instead of the external device 50, and the speaker apparatus 1 may receive a sound signal etc. via this antenna. The speaker apparatus 1 is also able to acquire sound signals that are collected by using a microphone t illustrated).

The speaker apparatus 1 includes an application unit 10, a storage 20, the vibration elements 31, and the panel P. The application unit 10 includes an acquisition unit 11, a carrier-wave generating unit 12, a modulation unit 13, a sound-volume adjusting unit 14, and amplifiers 15. The storage 20 stores directivity-angle information 21.

The application unit 10 includes (i) a computer that includes, for example, a Central Processing Unit (CPU), a Read Only Memory (ROM), a Random Access Memory (RAM), a Hard Desk Drive (HDD), an input/output port, etc. and (ii) various circuits.

The CPU of the computer reads and executes, for example, various programs stored in the ROM so as to function as the acquisition unit 11, the carrier-wave generating unit 12, the modulation unit 13, and the sound-volume adjusting unit 14 of the application unit 10.

At least one or all of the acquisition unit 11, the carrier-wave generating unit 12, the modulation unit 13, and the sound-volume adjusting unit 14 of the application unit 10 may be constituted of hardware such as an Application Specific Integrated Circuit (ASIC) and a Field Programmable Gate Array (FPGA).

The storage 20 corresponds to, for example, a ROM, a RAM, and a HDD. The ROM, the RAM, and the HDD are able to store the directivity-angle information. 21, information on various programs, etc. The application unit 10 may acquire the directivity-angle information 21 and various kinds of information via another computer or a portable recording medium connected therewith by a wired or wireless network.

The application unit 10 applies, to the vibration elements 31, a driving signal of the specific frequency f for generating the standing wave W in the panel P. The acquisition unit 11 of the application unit 10 acquires the above sound information that is output from the external device 50.

The acquisition unit 11 outputs, to the modulation unit 13, a sound signal among pieces of the acquired sound information. The acquisition unit 11 outputs a directivity-angle signal to the carrier-wave generating unit 12 and outputs a sound-volume signal to the sound-volume adjusting unit 14, among pieces of the sound information. The acquisition unit 11 adjusts a gain (amplitude) of the sound signal to be able to output the adjusted sound signal to the modulation unit 13. The acquisition unit 11 may include a low-pass filter for passing a signal of an audible frequency band, by employing this low-pass filter, it is possible to remove signals of other than the audible frequency band.

The carrier-wave generating unit 12 generates a carrier wave Wc on the basis of the directivity-angle signal input from the acquisition unit 11 and the directivity-angle information 21 of the storage 20, and outputs the carrier wave Wc to the modulation unit 13. The directivity-angle information 21 includes information obtained by associating (i) the directivity angle A indicating a direction in which a sound is generated from the panel P and (ii) the frequency of the carrier wave Wc with each other.

The carrier-wave generating unit 12 selects a frequency according to the directivity-angle signal among from pieces of the directivity-angle information 21, and generates the carrier wave Wc of this frequency. The frequency of this carrier wave Wc is of an ultrasonic band (for example, equal to or more than 20 kHz), and is of the specific frequency f at which the standing wave W is generated in the panel P. The carrier-wave generating unit 12 may change the specific frequency f of the carrier wave Wc in accordance with a user operation (not illustrated) to an operation unit.

The modulation unit 13 generates a modulation signal obtained by modulating, by the sound signal that is input from the acquisition unit 11, the carrier wave Wc input from the carrier-wave generating unit 12. The modulation unit 13 outputs this modulation signal to the sound-volume adjusting unit 14.

The modulation of the modulation unit 13 is performed by a predetermined modulation method such as an Amplitude-Modulation (AM) modulation, a Single-Sideband (SSB) modulation, a Doubly-Sideband (SSB) modulation, and an Frequency-Modulation (FM) modulation.

The sound-volume adjusting unit 14 adjusts a gain of the modulation signal, which is input from the modulation unit 13, in accordance with the sound-volume signal, which is input from the acquisition unit 11, so as to adjust the volume (sound pressure) to be output from the panel P. The modulation signal, whose gain is adjusted by the sound-volume adjusting unit 14, is individually amplified by the amplifiers 15, and is applied to the vibration elements 31 as AC driving signals.

The vibration elements 31 expand and contract in accordance with the applied driving signals so as to generate the standing wave W in the panel P. Antinodes of this standing wave W become the line-shaped sound sources S. These line-shaped sound sources S have the specific frequency f of the carrier wave Wc, and vibrate at an amplitude according the sound signal.

In this manner, the application unit 10 modulates the carrier wave Wc of an ultrasonic band by a sound signal of an audible frequency band, so that it is possible to give the directivity to the sound signal.

Next, relation between the frequency of the standing wave W and the directivity angle A will be explained with reference to FIG. 3A. FIG. 3A is a diagram illustrating relation between the directivity angle and a frequency of the standing wave W. In FIG. 3A, for convenience of explanation, the standing wave W is partially illustrated. Adjacent antinodes having the same phase in the standing wave W are indicated as line-shaped sound sources S1, S2.

Ultrasonic waves generated from the line-shaped sound sources S1, S2 have phase interference with each other, there exists an angle θ at which the ultrasonic waves attenuate each other and the angle θ at which the ultrasonic waves intensify each other. This is because the ultrasonic waves generated from the line-shaped sound sources S1, S2 have a phase difference in accordance with (i) a distance d between the line-shaped sound sources S1, S2 and (ii) the angle θ.

Specifically, the phases of the ultrasonic waves generated from the line-shaped sound sources S1, S2 at the arbitrary angle θ shifts from one to the other by a distance (dxcosθ). Let a wavelength of the carrier wave We be “λ”, at the angle θ at which the distance (dxcosθ) odd number times of a wavelength λ/2, the ultrasonic waves generated from the line-shaped sound sources S1, S2 attenuate each other r In other words, the ultrasonic waves are canceled at the angle θ at which the ultrasonic waves attenuate each other.

At the angle θ at which the distance (dxcosθ) is an integer number times of the wavelength λ, the ultrasonic waves generated from the line-shaped sound sources S1, S2 intensify each other, and a sound is generated in a direction of this angle θ. This angle θ at which the ultrasonic waves intensify each ether becomes the directivity angle A. The directivity angle A is an angle between the panel P and a direction for intensifying the ultrasonic waves.

In this manner, the directivity angle A changes in accordance with (i) the distance d between the adjacent line-shaped sound sources S and (ii) the wavelength λ of the carrier wave Wc. The directivity angle A is smaller as this distance d is larger. In a conventional parametric speaker, elements corresponding to the line-shaped sound sources S are fixed, and thus the distance d is not able to be changed.

Thus, in this parametric speaker, elements are respectively provided with delay circuits etc. so as to adjust the direct y angle A. When these delay circuits etc. are provided, a process becomes complicated and the number of parts increases, thereby leading to a rise in the manufacturing cost.

On the other hand, in the speaker apparatus 1 according to the embodiment, when a wavelength of the standing wave W, namely, the distance d between the line-shaped sound sources S is changed, it is possible to adjust the directivity angle A.

This wavelength of the standing wave W is able to be adjusted by the specific frequency f of the carrier wave Wc. In other words, the speaker apparatus 1 according to the embodiment is able to adjust the directivity angle A only by changing the specific frequency f of the carrier wave Wc. Specifically, the speaker apparatus 1 is able to reduce the distance d between the line-shaped sound sources S by increasing the specific frequency f of the carrier wave Wc, to be able increase the directivity angle A.

Therefore, the speaker apparatus 1 according to the embodiment does not need any complicated process, and is able to adjust the directivity angle A by an easy process. The speaker apparatus 1 does not need any part such as a delay circuit, so that it is possible to reduce the manufacturing cost of the speaker apparatus 1.

Meanwhile, the specific frequency f of the carrier wave Wc for generating the standing wave W in the panel P depends on attached positions of the vibration elements 31 on the panel P, etc. Relation between the specific frequency f and attached positions of the vibration elements 31 will be explained with reference to FIG. 3B.

FIG. 3B is a diagram illustrating one example of attached positions of the vibration elements 31 on the panel P. In FIG. 3B, the case is indicated in which the vibration elements 31 are attached so that they become line symmetry with respect to a longitudinal direction of the rectangular-shaped panel P.

As illustrated in FIG. 3B, when the two vibration elements 31 are respectively attached to both end parts of the panel P in the longitudinal direction, traveling waves according to a driving signal are generated from the two vibration elements 31, and the standing wave W is generated by superposition of these traveling waves.

Let the length of the panel P in the longitudinal direction be “L”, let distances from end edges of the panel P in the longitudinal direction to respective inner sides of the vibration elements 31 be “w”, and let distances from the end edges of the panel P in the longitudinal direction to respective outer sides of the vibration elements 31 be “r”. Let the wave number of the standing wave W to be generated in the panel P be “n”, when a relation of “L−(w+r)=(λ×n)/2” is satisfied, the standing wave W is generated in the panel P.

When the wavelength λ (=v/f) assigned to the above formula, it is possible to compute the specific frequency f according to the wave number n of the line-shaped sound sources S. The distance d (see FIG. 3A) is larger as the wave number n of the line-shaped sound sources S is smaller, as described above, the directivity angle A is smaller as the distance d is larger, and thus the directivity A to the panel P is smaller as the wave number n of the line-shaped sound sources S is smaller. In this manner, the wavelength λ is larger as the wave number n of the line-shaped sound sources S is smaller, the directivity angle A to the panel P is smaller as the specific frequency f is smaller, and thus the directivity angle A to the panel P is larger as the specific frequency f is larger. Herein, “v” indicates the velocity of the traveling wave propagating in the panel P.

In other words, the speaker apparatus 1 according to the embodiment is able to set the specific frequency f in accordance with the wave number n of the line-shaped sound sources S, which are to generated, to be able to shorten the distance d between the line-shaped sound sources S by increasing the wave number n. Information obtained by associating the specific frequency f and the directivity angle A with each other is stored in the storage 20 as the directivity-angle information 21 (see FIG. 2). This directivity-angle information 21 is set so that the specific frequency f is larger as the directivity angle A to the panel P is smaller.

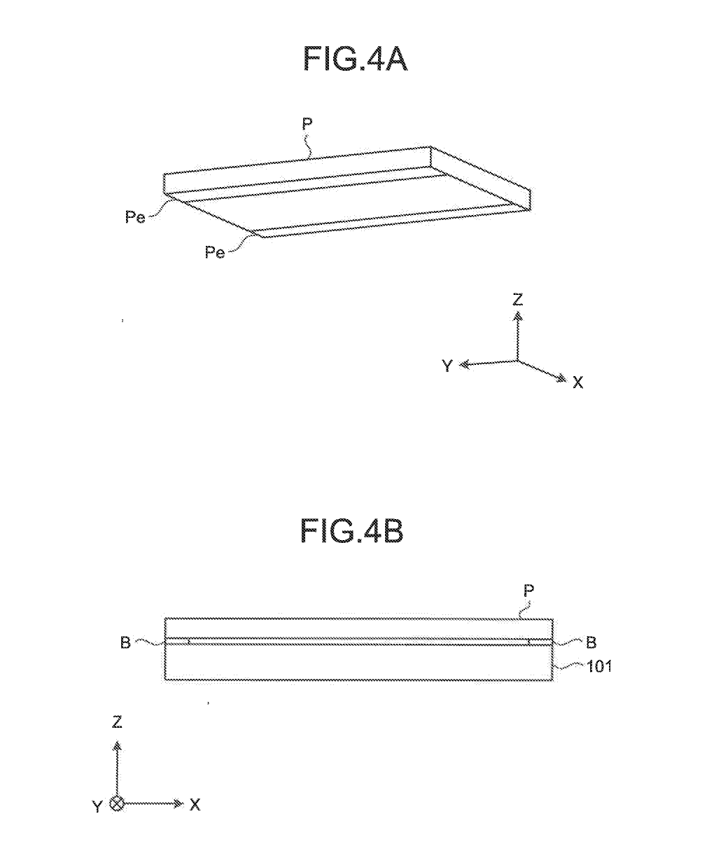

Next, a fixing example of the panel P will be explained with reference to FIGS. 4A and 4B. FIG. 4A is a diagram illustrating parts for fixing the panel P. FIG. 4B is a side view illustrating the panel P that is fixed to a fixed part 101.

In FIGS. 4A and 4B, for convenience of explanation, illustration of the application unit 10, the vibration elements 31, and the external device 50 is omitted. In FIGS. 4A and 4B, a three-dimensional orthogonal-coordinate system including, Z-axis whose positive direction is the upward vertical direction is illustrated.

As illustrated in FIG. 4A, when the panel P is a rectangular-shaped panel, long-side-end parts Pe of the panel P are fixed to the fixed part 101. Each of the “long-side-end parts Pe” is an area having a predetermined width from an end edge of the corresponding long side.

Herein, “fix” means that a positional relation between the panel P and the fixed part 101 does not change after the panel P is attached to the fixed part 101. In other words, the panel P is stiffly attached to the fixed part 101.

Specifically, fixing member B such as adhesive agent is applied along the long-side-end parts Pe and the panel P is fixed to the fixed part 101. In this case, it is preferable that agent that is hardly deformable after the fixing, in other words, curable agent is employed as the fixing member B.

This is for preventing vibration of the vibration elements 31 from being absorbed by the fixing member B. If the vibration of the vibration elements 31 is absorbed into the fixing member B, there exists a fear that generation of the standing wave W in the panel P is inhibited and the sound pressure is reduced.

In other words, in the speaker apparatus 1, the panel P is stiffly fixed to be able to efficiently generate the ultrasonic waves. The fixing member B is, for example, thermoset resin that is cured by heat, not limited thereto, screws, tapes, fixing tools for fixing the panel P and the fixed part 101 therebetween, or the like may be appropriately employed.

The long-side-end parts Pe of the panel P are fixed in order to reduce flexure of the panel P generated by vibration of the panel P. When the flexure of the panel P, which is caused by vibration of the vibration elements 31, is generated, as described above, generation of the standing wave W in the panel P may be inhibited or the sound pressure may be reduced.

Thus, when the long-side-end parts Pe of the panel P is fixed, the flexure is able to be reduced to be able to efficiently generate ultrasonic waves from the panel P. The parts for fixing the panel P is not limited to the long-side-end parts Pe, it is sufficient that the panel P is fixed to reduce the flexure, and thus any part or parts may be fixed.

As illustrated in FIG. 4B, when the fixed panel P is seen from the positive direction side of the Y-direction, the panel P is fixed to the fixed part 101 while placing a gap therebetween. This is for releasing, from this gap, back pressure that is the pressure generated on a reverse face side (negative direction side of Z-axis) of the panel P.

If no gap is provided, there exists a fear that the back pressure rebounds from the panel P to inhibit vibration of the panel P. Thus, when the gap is provided between the panel P and the fixed part 101, it s possible to prevent the inhibition, which is caused by the back pressure, of the vibration of the panel P.

The case is here exemplified in which the gap is generated by the fixing member B between the panel P and the fixed part 101, this gap may be generated by using material other than the fixing member B. A vibration controlling member for absorbing the back pressure may be arranged on or above the back surface of the panel P.

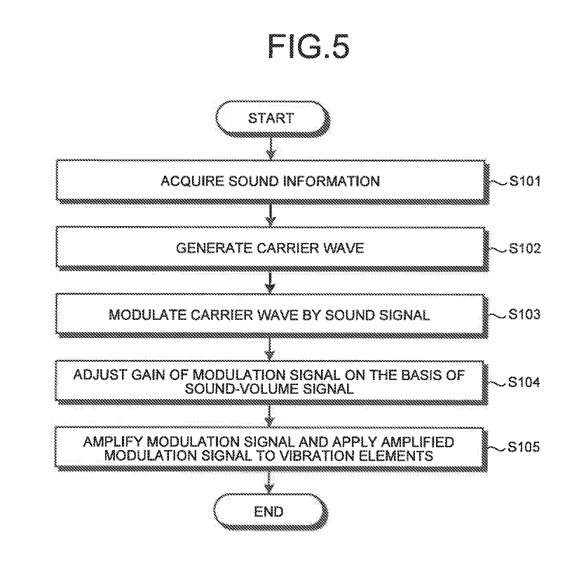

Next, a procedure for processes to be executed by the speaker apparatus 1 according t the embodiment will be explained with reference to FIG. 5. FIG. 5 is a flowchart illustrating the procedure for processes to be executed the speaker apparatus 1, and the procedure is repeatedly executed by the application unit 10.

As illustrated in FIG. 5, first, the acquisition unit 11 of the application unit 10 acquires sound information (Step S101). Next, the carrier-wave generating unit 12 generates the carrier wave Wc on the basis of this sound information (Step S102).

Next, the modulation unit 13 modulates the carrier wave We by a sound signal (Step S103). The sound-volume adjusting unit 14 adjusts a gain of a modulation signal on the basis of a sound-volume signal (Step S104), the amplifiers 15 amplifies the modulation signal and applies the amplified modulation signal to the vibration elements 31 (Step S105), and the process is terminated.

As described above, the speaker apparatus 1 according to the embodiment includes the panel 2, the one or more vibration elements 31, the acquisition unit 11, and the application unit 10. The one or more vibration elements 31 are arranged the panel P so as to vibrate the panel P. The acquisition unit 11 acquires sound information. The application unit 10 applies, to the one or more vibration elements 31, a driving signal of the specific frequency f for generating the standing wave W in the panel P, on the basis of the sound information acquired by the acquisition unit. Therefore, by employing the speaker apparatus 1 according to the embodiment, it is possible to miniaturize a speaker apparatus having the directivity.

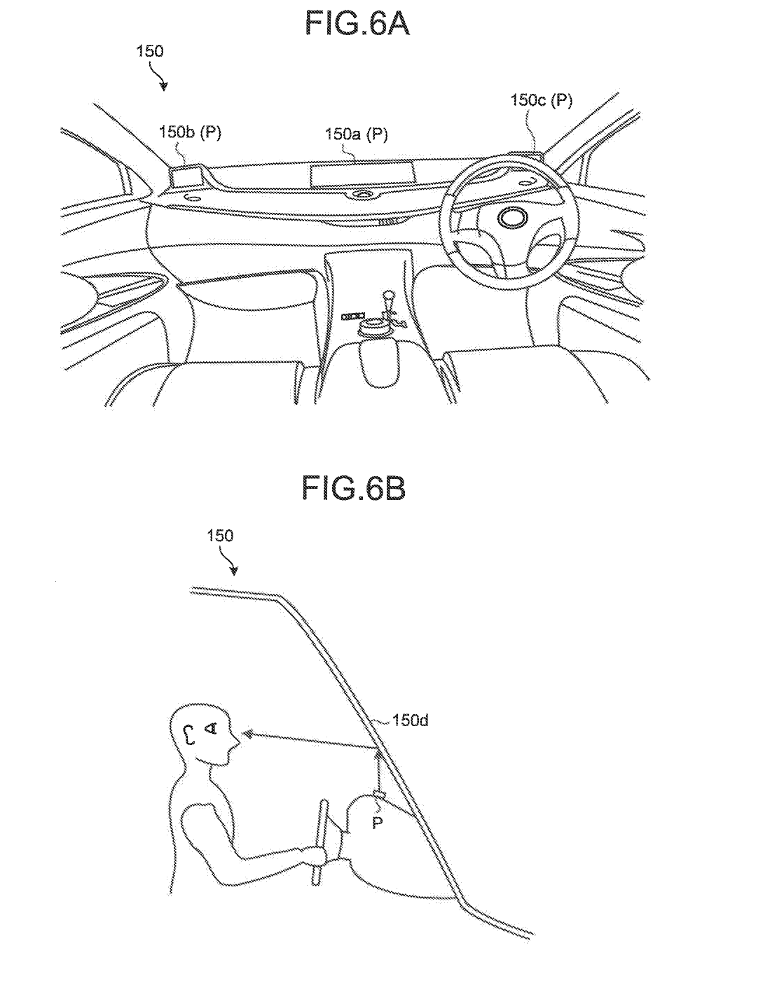

Next, specific examples of positions for attaching the panel P will be explained with reference to FIGS. 6A and 6B. FIGS. 6A and 6B are diagrams illustrating specific examples of the positions for attaching the panel P.

As described above, the panel P is able to be made of material having the transparency, such as glass. The “transparency” means transparent, translucent, etc. Thus, the panel P is able to be attached to a surface of a display such as a center display 150a

and side displays 150b, 150c illustrated in FIG. 6A.

In this case, the display is able to display images to an occupant of a vehicle 150 without shielding by the panel P. In other words, by employing the material having the transparency for the panel P, it is possible to improve the design.

As illustrated in FIG. 6B, the panel P may be placed in the rear of a meter hood of the vehicle 150. In this case, the speaker apparatus 1 may irradiate ultrasonic waves from the panel P toward a reflection wall 150d such as a windscreen of the vehicle 150.

These ultrasonic waves are reflected from the windscreen and are demodulated into a sound signal to be able to make a sound image on a windscreen. In this case, a driver hears the sound as if the sound was generated from the windscreen.

In other words, the speaker apparatus 1 generates ultrasonic waves toward the reflection wall 150d to be able to make a sound image at an arbitrary position. The reflection wall 150d is here exemplified as the windscreen, the reflection wall 150d may be a ceiling, a window glass, among other things. The speaker apparatus 1 may directly irradiate ultrasonic waves toward a driver from the panel P.

As illustrated in FIG. 6B, commonly, the panel P is arranged in the rear of a meter hood, which is dead space, so that it is possible to effectively utilize the space.

Attached positions of the panel P illustrated in FIGS. 6A and 6B are merely one example, not limited thereto. Moreover, the vibration elements 31 may be attached to a windscreen, a window glass, etc. so as to use this windscreen and window glass as the panel P.

In FIGS. 6A and 6B, the case is exemplified in which the speaker apparatus 1 is provided in the vehicle 150, not limited thereto. The speak apparatus 1 may be arranged in a position other than the vehicle 150, such as a station and a museum.

Meanwhile, when electrodes of the vibration elements 31 in the speaker apparatus 1 according to the embodiment are made waterproof, it is possible to place the panel P in a bathroom,out of doors, etc. Thus, the speaker apparatus 1 may be provided with a waterproof cover that covers the vibration elements 31. Thus, it is possible to improve a degree of freedom of a position for attaching the panel P. Moreover, it is sufficient that the waterproof cover is a cover having a waterproof property, and thus the waterproof cover is formed by resin material, for example.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A speaker apparatus comprising:
a panel;
one or more vibration elements that are arranged the panel so as to vibrate the panel;
acquisition unit that acquires sound information; and
an application unit that applies, to the one or more vibration elements, a driving signal of a specific frequency for generating a standing wave in the panel, based on the sound information acquired by the acquisition unit.

2. The speaker apparatus according to claim 1, wherein the panel is fixed to a fixed part by using one or more fixing members.

3. The speaker apparatus according to claim 2, wherein
the panel includes a rectangular-shape plate, and
the one or more fixing members fix one or more long-side end parts of the panel.

4. The speaker apparatus according to claim 1, wherein the application unit applies the driving signal obtained by modulating a carrier wave of the specific frequency in an ultrasonic band by a sound signal of an audible frequency band.

5. The speaker apparatus according to claim 1, wherein the application unit changes the specific frequency to adjust a direction in which a sound is generated from the panel.

6. The speaker apparatus according to claim 1, wherein the panel includes a member having transparency.

7. The speaker apparatus according to claim 1, wherein the one or more vibration element are covered by a cover having a waterproof property.

8. A speaker system comprising:
the speaker apparatus according to claim 1; and
an output device that outputs an input signal to the speaker apparatus.

9. A control method of a speaker apparatus, the apparatus including a panel and one or more vibration elements, the one or more vibration elements being arranged the panel so as to vibrate the panel,
the method comprising
acquiring sound information; and
applying, to the one or more vibration elements, a driving signal of a specific frequency for generating a standing wave in the panel, based on the sound information acquired in the acquiring.
